(19) United States
(12) Patent Application Publication
(10) Pub. No.: US 2006/0167945 A1
(43) Pub. Date: Jul. 27, 2006

(54) Addressing and access method for image objects in computer-supported medical image information systems

(75) Inventor: Wolfgang Trautner, Hessdorf (DE)

Correspondence Address: SCHIFF HARDIN, LLP;PATENT DEPARTMENT, 6600 SEARS TOWER, CHICAGO, IL, 60606-6473, US

(73) Assignee: Siemens Aktiengesellschaft

(21) Appl. No.: 11/333,746

(22) Filed: Jan. 17, 2006

(30) Foreign Application Priority Data
Jan. 21, 2005 (DE) 10 2005 002 981.7

(51) Int. Cl. G06F 17/00

(52) U.S. Cl. 707/104.1

(57) ABSTRACT

In an addressing and access method for image objects in computer-aided medical image information systems in the framework of a network-based array composed of, among other things, modality computers of image-generating systems, image workstations, data management computers of image storing and archiving systems, a logical archive address is generated for each image object, in which logical archive address all image object parts (in particular their specific attributes) are coded and from which unambiguous physical archive address of each image object part is calculated. The one image object part is physically stored under this calculated physical archive address.

### BACKGROUND OF THE INVENTION

1. Field of the Invention

The present invention in general concerns an optimized storage of image objects in computer-supported medical image information systems. The present invention in particular concerns a more economic and more powerful addressing and access method, for example in radiology information systems or other general image and management information systems (for example PACS, RIS etc.) in medical image data administration.

2. Description of the Prior Art

“Pure” image information systems (PACS, Picture Archiving and Communication System) are currently merged with administration-based radiology information systems (RIS) to form integrated information systems. A modern system concept is as follows (FIG. 1): The image-generating systems deliver the generated images as electrical signals to an image communication network. The images are collected in an image storage and archiving system. Normally such an image storage and archiving system is coupled with one or more hospital-specific servers. Stored images can be requested by a number of image workstations at different times from different sites and are shown on image monitors for assessment, consultation, research or teaching. The images can be compared and post-processed with one another and with images and information from earlier examinations, possibly from other departments or even other hospitals or medical practices. PACS enables the requesting doctors to send finished images over the digital communication network, and if applicable additionally over a wide area network (WAN), and to show these on the respective image workstations. A connection to a management information system RIS enables the exchange of patient and radiological performance data.

Individual sub-systems of a PACS can be produced by different manufacturers. Sub-systems are the image-generating systems, the communication network, the data retention system, the image workstations, the data management computer, the archive system etc. In order to ensure compatibility of these sub-systems, manufacturer-independent standards must be devised for the device interfaces, the image headers and image formats, for the communication protocols, the storage formats as well as for the control elements and the syntax of the user interface. National and international technical committees work on the establishment of such standards. In particular the DICOM standard is of particular importance for radiological information systems.

DICOM 3.0 (Digital Imaging and Communication) arose from the cooperation of the American College of Radiology (ACR) and the National Electrical Manufactures Association (NEMA). DICOM standardizes the structure of the formats and descriptive parameters for radiological images and commands for exchange of these images, as well as the specification of other data objects such as image sequences, examination series and findings. The specification of different methods for image data compression is also established in DICOM.

Corresponding to the DICOM standard, an image object in the DICOM format is composed of an (image) header portion and an (image) pixel portion. The header portion describes administration information (such as, for example, patient name, modality name, hospital etc.) while the pixel portion contains the actual pixel-based image content of the (radiological) image acquired by the respective modality.

It is disadvantageous that, at present, the complete image object (header portion and pixel portion) must be re-written given header modifications to image-relevant or patient-relevant parameters. Generally, a new identifier must also be entered into the databank in which the new (changed) image object is stored. The identifier presently serves for relocation of separately-stored image objects in PACS archiving systems.

A high storage capacity and resource occupation presently are required due to the storage of multiple image objects and identifiers, affecting both the CPU load and the network load (I/O). Image objects can presently be up to 300 Mbytes in size, and there often are several thousands of images in one series. A transfer and distribution of such image objects on various image workstations is presently notably network-intensive, since for even small deviations (for example due to modifications) of header data of the same image object, its entire pixel portion must also be transferred.

Different representation forms are also required for making a diagnostic finding and simple observation (viewing) of radiological images (for example in uncompressed and in compressed image formats JPEG2000, JPEGlossless, etc.); such different representation forms are generated for the presently separate databank entries and are thus stored redundantly (from a technical viewpoint).

The necessity of also having to archive image objects (in different representation forms), long-term, additionally requires enormous storage space.

### SUMMARY OF THE INVENTION

An object of the present invention is to provide an addressing and access method for image objects in medical image information systems that enables a more economic data storage compared to known methods, while permitting a higher-performing usage of the online data storage (for example RAID=Redundant Array of Independent Disks) as well as the connected databanks of the network-based array.

This object is achieved according to the invention by a method for image objects in computer-supported mechanical image information systems operating in a network-based array that can include among other things, modality computers of image-generating systems, image workstations, data management computers of image storing and archiving systems, wherein a logical archive address is generated for each image object, with all image object parts (in particular their specific attributes) being coded in the archive address, and from which one unambiguous physical archive address of each image object part is calculated, with the one image object part being physically stored under the calculated physical archive address.

The logical archive address according to the invention is composed of a specification of the protocol type, a hierarchical path specification and an option part.

The hierarchical path specification can include attributes that provide information about the separation of data among hospital, department or client levels (planes) etc., as well as about the size of the image object part, number of the data media, number of the directories and image object identification number.

The object part includes attributes that provide information about the image object type, the respective image object segment number, the version number and the image compression format.

Small image object parts according to the invention include the header, the superordinate header (meta-header) and the index part, and large image object parts according to the invention include the respective image part (pixel part).

The image object type can represent an individual image object (SINGLE), an individual image object in the DICOM format (DCM) or an image sequence in the DICOM format (SEQ).

Dependent on the image object type, the image object part represents the individual image object, the header, the superordinate header (meta-header), the index part or a corresponding image of the image sequence (pixel part).

In addition to the specifying attributes of the logical archive address, the physical archive address includes the physical path specification.

A small block (cluster) size of the file system on the data medium is set for small image object parts; a large block size of the file system on the data medium is advantageously set given large image object parts.

It is likewise advantageous to store the pixel part in different compression formats and, in fact, primarily in a compression format that is commonly used in the context of the network-based array.

The logical archive address and therewith the attributes are inventively stored in a conventional, commercial databank by means of a software module (business logic) and are read out again in the form of a databank query, while the physical archive address and therewith the image objects themselves are stored on an OS file system and are read out again by means of a software module (storage framework).

The interface between both software modules (storage framework and business logic) preferably is formed by a further software module (DICOM adapter or FastBLOB) that communicates with the components of the network-based array.

It is advantageous to physically store large and small image object parts separately on various levels.

It is likewise advantageous to derive the semantics of the logical as well as the physical archive address from the semantics of the conventional URL technology.

The above object also is achieved in accordance with the invention by a system that is suitable for implementation of a method described above.

### DESCRIPTION OF THE DRAWINGS

FIG. 1 schematically shows the basic structure of a PACS system.

FIG. 2 shows the hierarchical directory structure in a graphical representation.

FIG. 3 schematically shows the address-based pointer architecture.

FIG. 4 schematically shows the procedure for receiving an image object via the network.

FIG. 5 schematically shows the procedure for transmitting an image object via the network.

### DESCRIPTION OF THE PREFERRED EMBODIMENTS

As noted above, the present invention serves for a more economic and high-performance usage of online storage as well as of archives and databanks (data management systems), for example of PACS archive systems.

Image objects in PACS typically exist in the DICOM format and are by default comprised of header and pixel portions. The pixel portion contains the (image) content of the image acquired by the respective modality. The header portion contains administrative information like patient name, modality designation, hospital, etc.

In spite of this segmentation of an image in the DICOM format, DICOM images are presently stored as individual objects in file systems of, for example, PACS archives, and an individual object-specifying identifier is entered into a databank. If parameters of the header or image portion are changed (updated), the complete image object must be re-stored and a new identifier must be generated and entered, whereby very high storage and processor resources (CPU/IO) usage arises.

The present invention separately administers header portions and pixel portions of an image object according to economic and performance-oriented aspects with regard to the computer-based archiving. This is achieved by means of a more efficient storage in a databank of the attributes specifying the image object, the individual image object parts or the respective image object segments. The storage inventively ensues by means of a logical archive address that is generated by a software component (storage framework on a data management server (archive computer) of the respective archive in the PACS system.

This is normally a central server in a hospital that reacts to expansions, modifications and/or distributions (initiated by image workstations or modalities) of different image objects or image object parts in relatively short time periods (seconds, minutes).

The logical archive address is inventively designed such that the most important features of image objects or image object parts can be encoded therein. The simplest feature is the statement about whether the image object part represents a header portion or a pixel portion. Further features are patient-specific and hospital-specific administration data, the structuring of the underlying file system (size of the data medium (volume) to be used, number of the indexes (directories) on the data medium), the image object identification number, the image object type, the image object segment, the version identification as well as the compression format.

The encoding inventively ensues according to the standard URL technology (Unified Resource Locator), which describes a standardized logical addressing in other networks (especially on the Internet). In this manner, the specific design or the composition of the logical archive address enables the storage of all attributes in a databank which can in turn be queried by means of an access logic in the framework of an access.

The architecture of a possible, logical archive address (abbreviated as LA below) is described in the following.

An LA according to the present invention is in principle comprised of a specification of the protocol type (URL prefix), a hierarchical path specification (Hierarchical Directory Path) as well as an option part (OptionPart).

LA: = <URL Prefix> <Hierarchical Directory Path> ? <Option Part>

The protocol type (URL Prefix) is specified with file://, in contrast to http:// of an Internet address.

<URL Prefix> := file://

The hierarchical path specification (Hierarchical Directory Path) includes attributes that provide information about hospital, department, client (volume groups) as well as about the size of the image object part (part type), structuring of the underlying file system (volume, directory) and the image object identification number (OID).

| | |
|---|---|
| <Hierarchical Directory Path>: = | /g <Volume Groups> |
| | /p <Part Type> /v <Volume> |
| | /d <Directory> / <OID> |

The option part includes attributes that provide information about the image object (object type), number of the total image object segments (part count), the version number (version ident [sic]) and the image compression format (compression type).

| | |
|---|---|
| <Option Part> := | type = <Object Type> + p-count = <Part |
| | Count> + Version = <Version |
| | Ident> + CPR = <Compression |
| | Type> |

In the following, possible attribute entries are specified for illustration:
/g <Volume groups> here, for example, specifications of the appertaining institutions in the sense of the client capability can be separately stored:
   g0=hospital 1 or department 1
   g1=hospital 2 or department 2
   gn=etc.
/p <Part Type> the separation of the image object parts according to their size ensues with this; a smaller image object part is typically a header portion, a larger image object portion is a pixel portion:
   p0=smaller image object part, for example DICOM header
   p1=larger image object part, for example pixel portion of an individual image or of an image sequence.
/v <Volume> a specification of the volume units as expansion units in the data medium administration (for example of the partition of a hard drive storage) that possess a storage size ensues with this for example: v3: 500 Gbytes.
/d <Directory> a partitioning of the volume unit ensues with this, d0-d99, for example, corresponds to a sub-division of a volume unit into 100 sub-directories.
<OID> represents an object identifier that identifies the image object part to be stored, for example test1_{—}379066948.old
<Object Type> the object type of the image object part is labeled with this or, respectively, the classification under <Part Type> (p0 or p1) is specified in detail with this. What is registered is
   SINGLE in the case of a singleton, large image object (p1), for example a video or a video sequence,
   DCM in the case of a DICOM image object with only one pixel portion,
   SEQ in the case of a DICOM image object with multiple pixel portions, for example multiple slices of an image sequence.
<Part Count> number of the total image object parts of an image object
   1 given SINGLE
   2 given DMC, whereby one p0 and one p1 exist
   3 given DMC, whereby two p0's and two p1's exist
   4 given SEQ, whereby one p0 and two p1's exist,
   ≧4 given SEQ, whereby at least one p0 and at least two p1's exist.
Part < Part Nr> a number of the individual image object parts of an image object herewith ensues with
(only given physical archive address) part 0 in the case of p0 and meta-header
   part 1 in the case of p0 and header
   part 2 in the case of p1 and DMC (pixel portion)
   part 3 in the case of p0 and SEQ (directory)
   part 2 in the case of p1 and SEQ (first image)
   part 4 in the case of p1 and SEQ (second image).
<Version Ident> a five-digit number is herewith assigned as a version identifier for the image object, for example 5.0.3.0.0,
(only given logical archive address) whereby the first digit specifies the total number of all modified versions with regard to the image objects (5 in this example) and the digits 2 through 5 represent the current version of the corresponding image object part (part0=0, part1=3, . . . in this example).
v <Version ID> alone represents the version identifier of the (only given physical archive address) corresponding image object part (corresponding to the part number)
<Compression Type> the designation of the corresponding compression format ensues in which the pixel portion exists ensues with this, coded with a DICOM-specific transfer syntax (for example JPEG2000: CPR=1.2/840.10008.1.2.1 in the case of a compression)

The logical archive address is the address of an image object (normally comprised of a plurality of image object parts) that is stored in a special attribute of the databank of the data management computer of a PACS archive system. Since the logical archive address is always unambiguous for the each image object, image objects are addressed as a single object on the logical plane (databank). The inventive usage of a single logical archive address for all image object parts and their different representation forms reduces the storage volume in the databank.

Nevertheless, an image object must also be physically stored in the archive system.

For reasons of performance and volume optimization that have already been discussed, the storage on a physical level (file system of the data management computer) inventively ensues separated according to the respective image object parts (meta-header portion, header portion, directory portion, pixel portion etc.). The physical addressing of the respective image object part is respectively derived from the logical archive address and, as what is known as a physical archive address (PhA), represents a likewise uniform addressing scheme like that of the logical archive address (LA).

In contrast to the logical archive address, in the physical archive address the physical access path (rootpath) is specified at the beginning instead of the protocol type (file://), which physical access path exactly references [points to] the hardware storage space at which the addressed image object part is physically stored.

<rootpath> :=C:\sdm\output\storage\objects

Furthermore, Part Number (<Part Nr>) is specified at the antepenultimate position in the file name, via which Part Number a concrete image object part or, respectively, image object segment is addressed.

part<Part Nr> 0: p0/part0 (meta-header portion)

1: p0/partl (header portion)
3: p0/part3 (directory portion)
2: p1/part2 (pixel portion)
4: p1/part4 (pixel portion, second image (segment) given sequence)
33: p1/part33 image (segment) 31 given sequence

Finally, only the version number of the corresponding image object part (part) is specified at the penultimate position in the file name, since in PhA representation the five-digit LA representation can be omitted.

<VersionlD>=V5 (fifth version of this part)

In the following, LA and PhA are contrasted and examples are specified:

The general representation form of an inventive, logical archive address in the databank reads:

LA := file://g <Volume Groups> / p <Part Type> / v <Volume> / d /
<Directory> /
<OID> ? type = <Object Type> + p_count = <Part Count> + version =
<Version Ident> + CPR = <Compression Type>.

The general representation form of an inventive, physical archive address in the file system reads:

PhA := <root path> / g <Volume Groups> / p
<Part Type> / v <Volume> / d
<Directory> / <OID> _{—} <Object Type> _{—} count
<PartCount> _part <part Nr> _{—} v
<Version ID> _{—} cpr <Cpr Type>.

Example for LA with header versions 5

| a) | file:///g0/p0/v2/d0/testl_379066948.oid? |
|---|---|
| | ype = DCM + p_count = 2 + version = 5.0.5.0.0 + CPR = |
| | 1.2.840.10008.1.2.1 |

Example for PhA with header version 5

| | |
|---|---|
| a) | C:\sdm\output\storage\objects\g0\p0\v0\d0\ |
| | testl_379066948.oid_DCM |
| | _count2_partl_v5_cpr1.2.840.10008.1.2.1 |

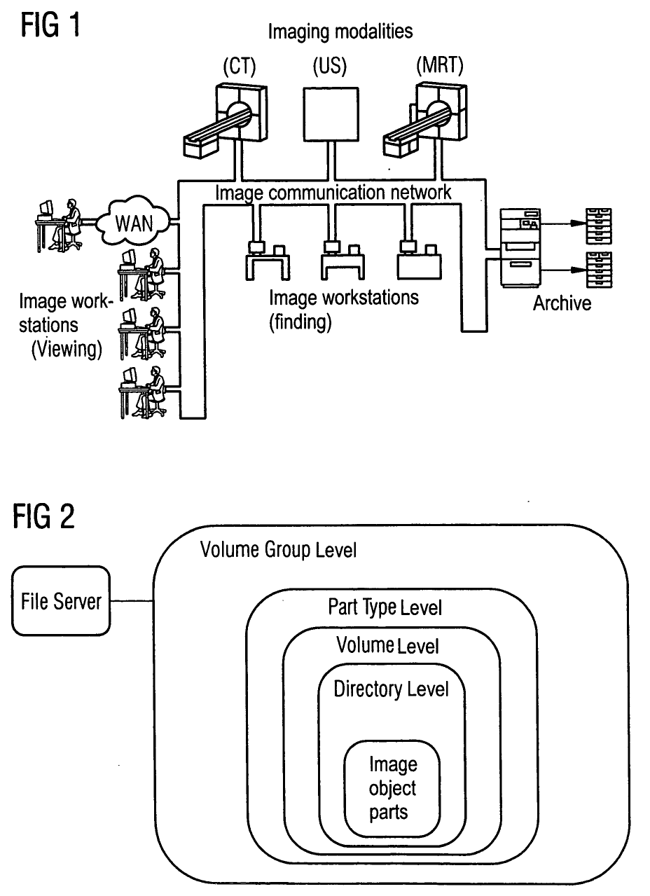

FIG. 2 schematically shows the hierarchical directory structure corresponding to the hierarchical path specification in an LA as well as in a PhA up to the level of the image object parts. The file server is connected with the highest hierarchy level, the volume group level. The division into large and small image object parts ensues in the part type level, in principle thus the division into header portion and pixel portion that is effected in the LA and PhA via the portion type (<Part Type>=p0 or p1).

This separation as well as the refined division of the image object via still further attributes in LA and PhA enables the corresponding image object to be deconstructed into many different image object parts that are stored separate from one another on the file system of the archive computer.

The separate storage of the individual image object parts of an image object has a series of advantages relative to the storage/archiving of a non-separated image object.

A number of different header portions can be associated with a single pixel portion. This means that only the header itself must be rewritten given a modification of the header (or meta-header) portion of an image object; the pixel portion remains unchanged, merely the version identifier is adapted in the LA or, respectively, in the PhA.

By means of the separation it is also possible to send only header updates to workstations for image objects (image object parts) that are already loaded at the workstations. In contrast to commercially available solutions, unnecessary storage capacities and network loads are avoided with this.

The separation of the image object parts enables an adaptation of the file system block size to the respective image object part. A file system cluster is the smallest unit on a storage device that can be read or written given an access. For large image object parts (for example pixel portions up to 300 Mbytes), large blocks (for example 128 KB) thus make sense in order to read quickly, since overall fewer clusters must be read. For small image object parts (for example header portions with 100 bytes), a small block (1 KB) represents the best solution in order to avoid waste and therewith valuable storage space occupation. Inefficiency occurs when, given the use of a large block and small objects, only a smaller part of a block is occupied by the object; the remainder (designated as waste) represents unusable storage space.

A further advantage results by the separate storage of the image object parts (for example the header portion and the pixel portion) on various partitions, thus on physically separate devices (hard disks), with a temporally parallel access to the part objects being enabled. This header and pixel portions thus also can be simultaneously read and transmitted given multiple requests.

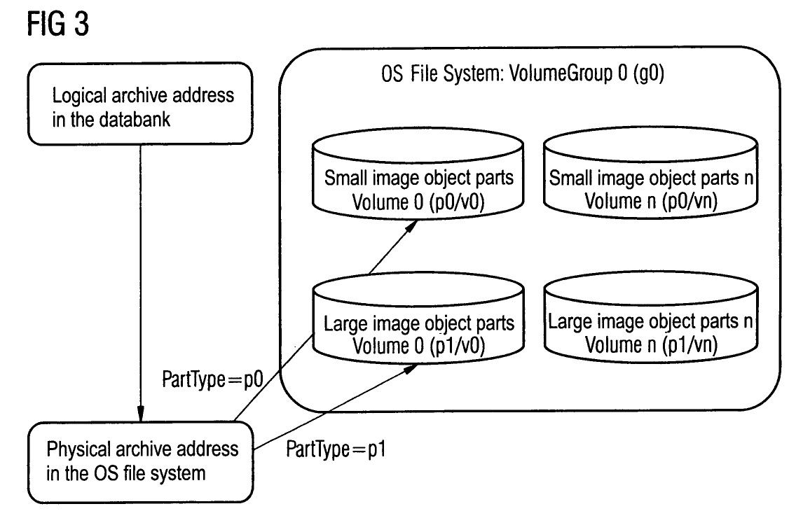

This is illustrated in FIG. 3. Two PhA's that enable a simultaneous parallel access to a large image object part (pixel portion, p1) as well as to a smaller image object part (header portion, p0) are generated by an evaluation of the LA. Such a parallel access to header portion and pixel portion has a performance-increasing effect, like the file cluster size adaptation.

Due to the ability being able to modify only the header portion independent of the pixel portion, and thus being able to achieve a header version customization, the implementation of an UNDO function and thus a checking of the image object history in the event of error is likewise possible. The radiological workflow is hereby improved and the medical service process is accelerated.

A further advantage is achieved by the storage, and therewith the possibility of an “immediate transmission,” of image objects or image object parts (in particular the pixel portions) in different compression formats (representation forms). These are inventively encoded in the LA as well as in the PhA due to the respective compression type (<Compression Type>) and can be appropriately taken into account given a databank query.

The storage of image object parts in a different compression format (for example JPEG2000, JPEGlossless) has the advantages that compressed image objects enable a faster transfer and that the required image workstations (that, among one another, respectively favor different representation forms based on user-specific, case-specific viewpoints) do not make ad hoc generation on the archive computer necessary. An ad hoc generation (also called “on the fly generation”) effects a conversion into the desired (requested) format of the requested image object (image object part) immediately before the transmission of the image object over the network and reduces the reaction time of the archive due to the extraordinarily high CPU load of the server during the compression implemented thereby.

An advance compression requires fewer CPU capacities than an ad hoc generation and unburdens the performance of the archive system. For a sample for which compression is desired, not only are the transfer times shortened, but also the reaction times of the databank query (user request are shortened).

Nevertheless, image objects are not archived in all possible compression formats in order to avoid an unjustifiable administration expenditure of too many different compressions.

In order to account for the compression format in databank queries, a special compression identifier is inventively incorporated into the LA as well as into the PhA. Image object (in particular pixel) data can be stored in different compressions and resolutions (but also uncompressed) in this manner. The identification ensues by means of the special transfer syntax of the compression code. If no compressed version of an image object is present in the archive, the specification of a compression identifier (<CPR>) is not necessary.

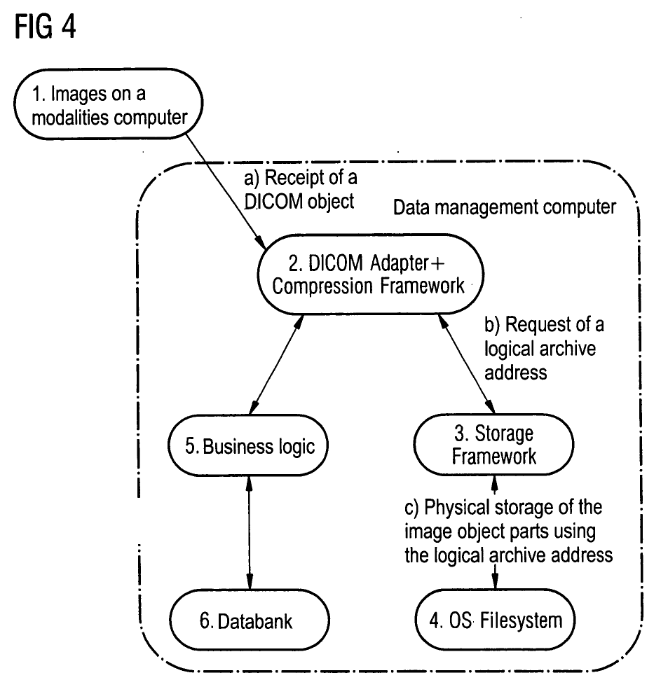

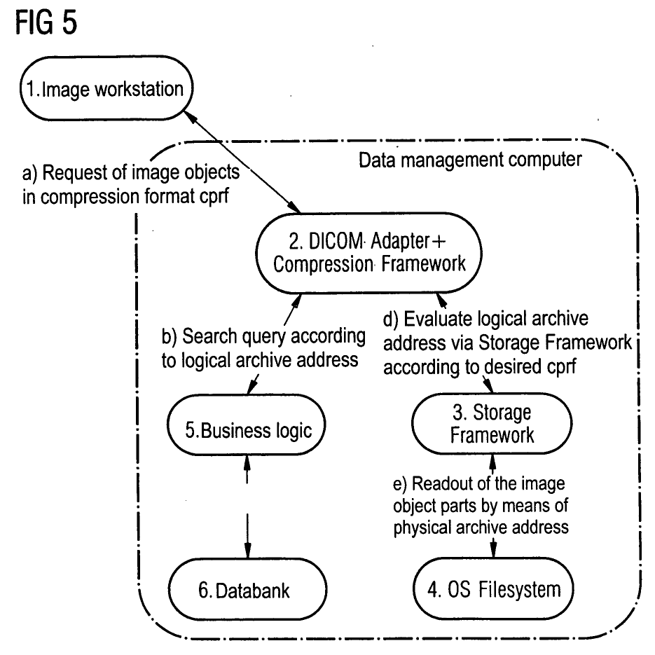

The inventive addressing and access method for image objects in medical image (archive) information systems based on an unambiguous logical archive address as well as on unambiguous physical archive addresses derived therefrom, is illustrated in the following using two exemplary embodiments (FIGS. 4 and 5):

I. Receipt of Image Objects of a Modality on the Network

The goal is to incorporate an image object generated on an imaging modality into an archive. The image object exists in the DICOM format on the computer of the imaging modality and is transferred over a network connection (similar to the Internet) to a data management computer (archive computer) of an archive.

The interface of the archive computer via which the archive computer communicates is what is known as a DICOM adapter or a FAST BLOB. The archive computer also has a databank as well as an OS file system for administration of the archive data on storage media. The DICOM adapter communicates with the databank via a business logic (software component), and with the OS file system via a storage framework (further software component).

The DICOM image object on the modality computer is received by the DICOM adapter of the archive computer as a DICOM object. The DICOM adapter thereupon requests an inventive logical archive address from the storage framework, which logical archive address the storage framework generates from the DICOM data of the DICOM object based on the inventive procedure/algorithm.

Based on a further inventive procedure/algorithm, the storage framework furthermore derives a number of physical archive addresses from the logical archive address it generated itself, by means of which physical archive addresses the DICOM object is dissected and is stored partitioned in this manner in the OS file system. The dissection ensues such that the original, uniform image object in the DICOM format is present as much as possible in the form of individual image object parts on the OS file system, and each part can be localized via a separate physical archive address. Parts are all header portions and pixel portions in the most varied formats in which a DICOM image object can be separated and physically stored.

The DICOM adapter also stores the logical archive address in the databank via the business logic. At this point in time, the DICOM object generated by the modality is visible in the (medical information) synchronization signal and can be queried from any image workstations.

II. Queries of an Archived Image Object or, Respectively, of an Image Object Part by an Image Workstation

The goal is to read out an image object part requested from an image workstation and stored in an archive and to transmit said image object part to the image workstation. The user at the aforementioned image workstation would like to load the image object part in a specific compression format cpr. The OID (for example test1_{—}379066948.oid) of the image object is available to the user.

Based on the OID, the DICOM adapter of the archive initiates a search request (Engl.: query), whereby the business logic reads out the corresponding logical archive address and transmits it to the DICOM adapter. The DICOM adapter in turn transmits this logical archive address to the storage framework which evaluates this and reads the image object (part) in the desired compression format from the OS file system based on the evaluation (generation or, respectively, finding of the physical archive address of the corresponding image object part or, respectively, of a part or all image object parts). If the image object (part) is not present in the desired compression format, a corresponding compression must be generated ad hoc. Such a compression software (compression framework) is typically activated on the level of the DICOM adapter or, respectively, is contained in this.

Finally, the DICOM adapter sends the image object (part) to the requesting image workstation via standard DICOM mechanisms.

Alternatively, the present invention can be combined with other DICOM-based proprietary transmission formats.

The inventive method as well as its advantages are briefly summarized in the following:

Image objects are addressed as a single object (unambiguous logical archive address per image object) on the logical plane (databank). On the physical level (file system), the image object is divided up, dissected into different image object parts that are respectively, separately stored optimized for performance and volume (one physical archive address per for each image header portion and each image pixel portion). A single logical archive address for all image object parts and representation forms reduces the storage volume in the databank. The uniform addressing scheme provided by the physical archive addressing enables the location of image objects in the event of catastrophe (for example loss of the databank). If the physical archive address of an image header portion is known, the other image object parts can also be found and vice versa. Redundancies (in the sense of storage occupation) are avoided via separate storage of the varying header portions and the constant pixel portions.

An UNDO function can be realized via a versioning of the header portions (allocation of a version number give modification of header portions), so that in the event of error the image object history can be reconstructed. A file system block generation adapted to the image object part size achieves a smaller (storage) volume consumption and a higher throughput in connection with the parallel access possibility to the individual image object parts. The network performance is increased and the CPU of the sender and the receiver is reduced via the transmission of the image in a pre-configured resolution (specific compression format). For this purpose, pixel portions of an image object are either stored or administered in various (customary) compression formats or they are generated with a compression software before the transmission. In the latter case the loading of the server CPU is omitted (the decision between both cases is made dependent on the server processor capacity).

Although modifications and changes may be suggested by those skilled in the art, it is the intention of the inventor to embody within the patent warranted hereon all changes and modifications as reasonably and properly come within the scope of his contribution to the art.

I claim as my invention:

1. An addressing and access method for image objects in a computer-supported medical information system comprising networked modality computers of image-generating systems, image workstations, and data management computers of image storage and archiving systems, comprising the steps of:
for each image object, generating a logical archive address containing all image object parts of that image object are coded;
from each image object part in the logical archive address for the image object containing that image part, calculating an unambiguous physical archive address for the image object part; and
physically storing the image object parts at the respective physical archive addresses calculated therefor.

2. A method as claimed in claim 1 comprising generating said logical archive address for each image object to include a specification of a protocol type for the image object, a hierarchical path specification to the image object, and an option part for the image object.

3. A method as claimed in claim 2 comprising generating said logical archive address to include, in said hierarchical path specification, information describing a separation of data of the image object with regard to hospital, department and client levels, information describing a size of the image object, information describing a number of data media associated with the image object, a number of directories associated with the image object, and an image object identification number.

4. A method as claimed in claim 2 comprising generating said logical archive address to include, in said object part, information describing an image object type of the image object, an image object segment number of the image object, a version number of the image object, and an image compression format for the image object.

5. A method as claimed in claim 4 comprising selecting said image object type from the group consisting of an individual image object, an individual image object in the DICOM format, and an image sequence in the DICOM format.

6. A method as claimed in claim 5 comprising, dependent on said image object type, representing the image object part as a representation from the group, consisting of the individual image object, a header, a superordinate header, an index part, and image from said image sequence.

7. A method as claimed in claim 1 comprising employing, as said physical archive address, a physical path specification and attributes of said logical archive address.

8. A method as claimed in claim 1 wherein said image object parts comprise a header, a superordinate header, an index part and an image pixel part, and designating the header, the superordinate header and index part as small image object parts and designating the image pixel part as a large image object part, and designating a storage capacity for physically storing the image object part dependent on whether the image object part is designated as a small image object part or a large image object part.

9. A method as claimed in claim 8 comprising, if said image object part is a small image object part, physically storing said small image object part in a small block size of a file system of a data storage medium.

10. A method as claimed in claim 8 comprising, if said image object part is a large image object part, physically storing said large image object part in a large block size of a file system of a data storage medium.

11. A method as claimed in claim 1 wherein said image object comprises an image pixel part as one of said image object parts, and wherein a plurality of different compression formats are used with respective frequencies of occurrence in said network, and comprising compressing said image pixel part with one of said compression formats dependent on the frequency of occurrence of that compression format in said network, to obtain a compressed image pixel part, and physically storing said compressed image pixel part.

12. A method as claimed in claim 1 comprising storing said logical archive address in a commercial databank using a software module, and reading out said logical archive address from said commercial databank as an interrogation of said commercial databank.

13. A method as claimed in claim 1 comprising storing said physical archive address and said image object parts in an OS file system, and reading out said physical archive address and said image object parts from said OS file system using a software module.

14. A method as claimed in claim 1 comprising storing said logical archive address in a commercial databank using a first software module, and reading out said logical archive address from said commercial databank as an interrogation of said commercial databank, and storing said physical archive address and said image object parts in an OS file system and reading out said physical archive address and said image object parts from said OS file system using a second software module, and communicating between said commercial databank and said OS file system with a third software module comprising an interface, and also communicating with said network via said third software module.

15. A method as claimed in claim 14 comprising designating said image object parts as being either a large image object part or a small image object part, and physically storing said large and small image object parts respectively in different partitioned regions of said OS file system.

16. A method as claimed in claim 1 comprising generating said logical archive address and said physical archive address using URL technology semantics.

17. A computer-supported medical information system comprising:
a network comprising networked modality computers of image-generating systems, image workstations, and data management computers of image storage and archiving systems;
a processor connected to said network that generates, for each image object, a logical archive address containing all image object parts of that image object are coded, and that calculates from each image object part in the logical archive address for the image object containing that image part, an unambiguous physical archive address for the image object part; and
a memory connected to the network in which the image object parts are stored at the respective physical archive addresses calculated therefor by said processor.
